(19) United States
(12) Patent Application Publication
(10) Pub. No.: US 2012/0075882 A1
(43) Pub. Date: Mar. 29, 2012

(54) LIGHT EMITTING DIODE MODULE

(75) Inventors: JIAN-SHIHN TSANG, Hukou (TW); CHING-CHUNG CHEN, Hukou (TW); YA-WEN LIN, Hukou (TW)

(73) Assignee: ADVANCED OPTOELECTRONIC TECHNOLOGY, INC., Hsinchu Hsien (TW)

(21) Appl. No.: 13/209,446

(22) Filed: Aug. 15, 2011

(30) Foreign Application Priority Data
Sep. 23, 2010 (CN) 201010289814.3

(51) Int. Cl. F21V 7/22; F21V 9/16

(52) U.S. Cl. 362/606; 362/84; 362/612

(57) ABSTRACT

An LED module includes an LED and a light-guiding board. The light-guiding board includes a light-incident face facing the LED, a light-emergent face, a light-reflecting face opposite to the light-emergent face, and a light-converting layer containing phosphors therein. Light emitted from the LED sequentially moves the light-incident face, the light-converting layer and the light-emergent face to leave the light-guiding board. The light-converting layer has a uniform thickness.

### TECHNICAL FIELD

The disclosure generally relates to a light emitting diode module.

### DESCRIPTION OF RELATED ART

As new type light source, LEDs are widely used in various applications. A conventional LED module includes a base, a pair of leads fixed in the base, a die mounted on the base and electrically connected to the leads and an encapsulant secured to the base and sealing the die. In order to produce white light, the die is made of a predetermined material to emit blue light, and large quantities of yellow phosphors spread on the encapsulant. The yellow phosphors absorb the blue light from the die and are excited thereby to produce yellow light. The yellow light mixes with the blue light to generate white light.

However, the phosphors exposed are prone to be ruined by accident.

Therefore, an LED module is desired to overcome the above described shortcomings.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is a schematic view of an LED module in accordance with a first embodiment of the present disclosure.

FIG. 2 is a schematic view of an LED module in accordance with a second embodiment of the present disclosure.

FIG. 3 is a schematic view of an LED module in accordance with a third embodiment of the present disclosure.

FIG. 4 is a schematic view of an LED module in accordance with a fourth embodiment of the present disclosure.

FIG. 5 is a schematic view of an LED module in accordance with a fifth embodiment of the present disclosure.

FIG. 6 is a schematic view of an LED module in accordance with a sixth embodiment of the present disclosure.

### DETAILED DESCRIPTION

Embodiments of an LED module will now be described in detail below and with reference to the drawings.

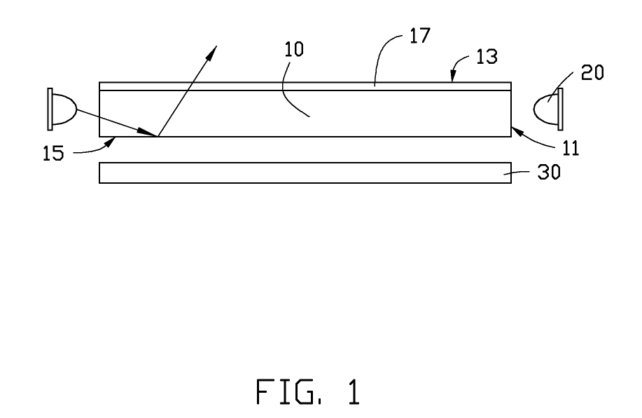

Referring to FIG. 1, an LED module in accordance with a first embodiment comprises a light-guiding board 10, two LEDs 20 arranged facing two opposite lateral sides of the light-guiding board 10, respectively, and a light-reflecting board 30 facing a bottom of the light-guiding board 10. The board 10 has a shape of a flat plate.

The light-guiding board 10 may be made of epoxy silicone, polycarbonate, polymethylmethacrylate or other transparent materials. The light-guiding board 10 comprises two light-incident faces 11, a light-emergent face 13, a light-reflecting face 15 opposite to the light-emergent face 13, and a light-converting layer 17. The two light-incident faces 11 face the two LEDs 20 to receive the light emitted from the two LEDs 20, respectively. The light-reflecting face 15 reflects the light moving through the two light-incident faces 11 and striking on the light-reflecting face 15 towards the light-emergent face 13. The light-reflecting board 30 faces the light-reflecting face 15 to reflect some light passing through the light-reflecting face 15 towards the light-guiding board 10. The light-reflecting board 30 is parallel to the light-reflecting face 15. The light-converting layer 17 contains phosphors therein. The phosphors may be YAG phosphors, RGB phosphors, or RG phosphors. The phosphors in the light-converting layer 17 can be excited by the light from the LEDs 20 to emit light with a wave length different from that of the light generated by the LEDs 20. A mixture of the lights with different wave lengths could obtain a light with a desired color such as white. The light-converting layer 17 is parallel to the light-emergent face 13. In the first embodiment of this disclosure, the light-converting layer 17 is formed at a top side of the light guiding board 10; a top face of the light-converting layer 17 is the light-emergent face 13. A thickness of the light-converting layer 17 is uniform. The light-emergent face 13 is parallel to the light-reflecting face 15.

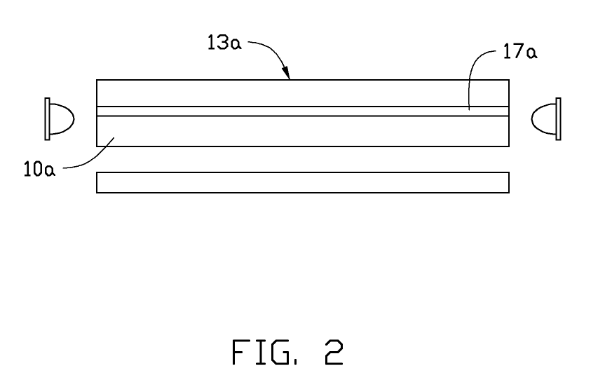

Referring to FIG. 2 also, an LED module in accordance with a second embodiment is shown. In this embodiment, differing from the first embodiment, the light-converting layer 17a is formed at a middle portion of the light-guiding board 10a, and a top face of the light-converting layer 17a is below and spaced a distance from the light-emergent face 13a.

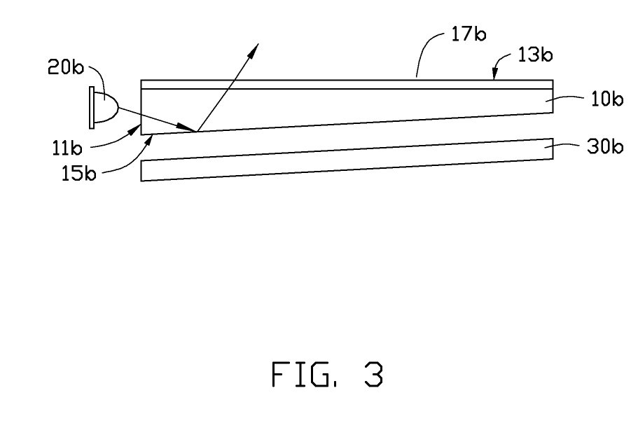

Referring to FIG. 3, an LED module according to a third embodiment comprises a light-guiding board 10b, an LED 20b arranged facing a lateral side of the light-guiding board 10b, and a light-reflecting board 30b facing a bottom of the light-guiding board 10b.

The light-guiding board 10b may be made of epoxy silicone, polycarbonate, polymethylmethacrylate or other transparent materials. The light-guiding board 10b comprises a light-incident face 11b, a light-emergent face 13b, a light-reflecting face 15b opposite to the light-emergent face 13b, and a light-converting layer 17b. The light-incident face 11b faces the LED 20b to receive the light emitted from the LED 20b. The light-reflecting face 15b reflects the light moving through the light-incident face 11b and striking on the light-reflecting face 15b towards the light-emergent face 13b. The light-reflecting board 30b faces the light-reflecting face 15b to reflect some light passing through the light-reflecting face 15b towards the light-guiding board 10b. The light-reflecting board 30b is parallel to the light-reflecting face 15b. The light-converting layer 17b contains phosphors therein. The phosphors may be YAG phosphors, RGB phosphors, or RG phosphors. The phosphors in the light-converting layer 17b can be excited by the light from the LED 20b to emit light with a wave length different from that of the light generated by the LED 20b. A mixture of the lights with different wave lengths could obtain a light with a desired color such as white. The light-converting layer 17b is parallel to the light-emergent face 13b. In the third embodiment of this disclosure, the light-converting layer 17b is formed at a top side of the light guiding board 10b; a top face of the light-converting layer 17b is the light-emergent face 13b. A thickness of the light-converting layer 17b is uniform. The light-reflecting face 15b is sloping relative to the light-emergent face 13b.

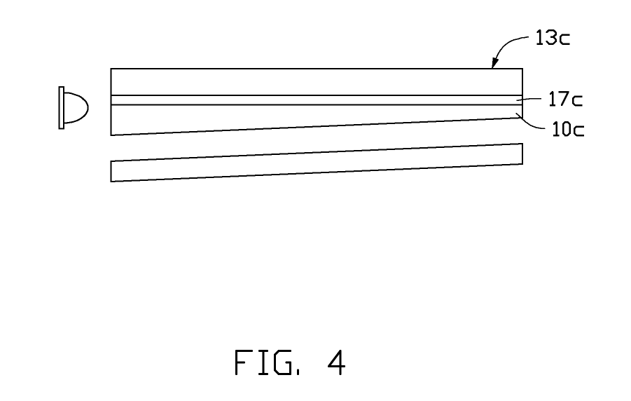

Referring to FIG. 4 also, an LED module in accordance with a forth embodiment is shown. In this embodiment, differing from the third embodiment, the light-converting layer 17c is formed at a middle portion of the light-guiding board 10c, and a top face of the light-converting layer 17c is below and spaced a distance from the light-emergent face 13c.

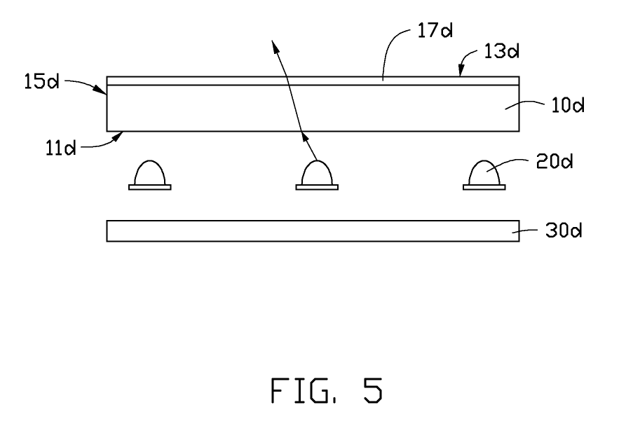

Referring to FIG. 5, an LED module according to a fifth embodiment comprises a light-guiding board 10d, a plurality of LEDs 20d arranged facing a bottom of the light-guiding board 10d, and a light-reflecting board 30d arranged below the LEDs 20d.

The light-guiding board 10d may be made of epoxy silicone, polycarbonate, polymethylmethacrylate or other transparent materials. The light-guiding board 10d comprises a light-incident face 11d, a light-emergent face 13d opposite to the light-incident face 11d, two opposite light-reflecting faces 15d, and a light-converting layer 17d. The light-incident face 11d faces the LEDs 20d to receive the light emitted from the LEDs 20d. In the fifth embodiment of this disclosure, a bottom face of the light-guiding board 10d is the light-incident face 11d. The light-reflecting faces 15d reflect the light moving through the light-incident face 11d and striking on the light-reflecting faces 15d towards the light-emergent face 13d. The LEDs 20d are located between the light-incident face 11d and the light-reflecting board 30d. The light-reflecting board 30d is parallel to the light-incident face 11d. The light-reflecting board 30d faces upwardly the LEDs 20d and the light-incident face 11d to reflect some light downwards from the LEDs 20d and the light-incident face 11d towards the light-incident face 11d. The light-converting layer 17d contains phosphors therein. The phosphors may be YAG phosphors, RGB phosphors, or RG phosphors. The phosphors in the light-converting layer can be excited by the light from the LEDs 20d to emit light with a wave length different from that of the light generated by the LEDs 20d. A mixture of the lights with different wave lengths could obtain a light with a desired color such as white. The light-converting layer 17d is parallel to the light-emergent face 13d. In the fifth embodiment of this disclosure, the light-converting layer 17d is formed at a top side of the light guiding board 10d; a top face of the light-converting layer 17d is the light-emergent face 13d. A thickness of the light-converting layer 17d is uniform. The light-emergent face 13d is parallel to the light-incident face 11d.

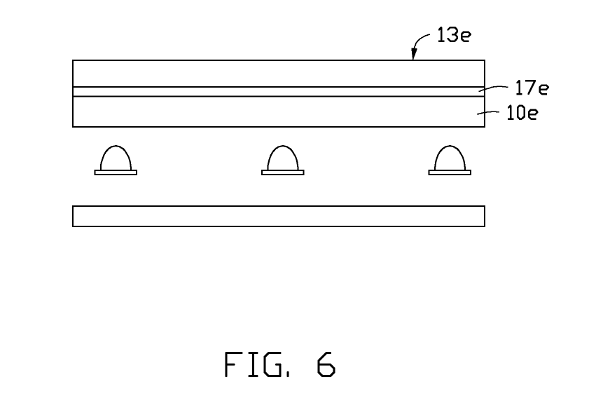

Referring to FIG. 6 also, an LED module in accordance with a sixth embodiment is shown. In this embodiment, differing from the fifth embodiment, the light-converting layer 17e is formed at a middle portion of the light-guiding board 10e, and a top face of the light-converting layer 17e is below and spaced a distance from the light-emergent face 13e.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being preferred or exemplary embodiments of the disclosure.

What is claimed is:

1. An LED module, comprising:
an LED for emitting light; and
a light-guiding board comprising a light-incident face facing the LED and receiving light from the LED, a light-emergent face for exit of the light from the light-guiding board, and a light-converting layer containing phosphors therein, the light which enters the light-guiding board exiting the light-emergent face after moving through the light-converting layer, wherein the light-converting layer is excited by the light to generate another light with a different wavelength, a mixture of the light and the another light generating a third light having a color different from those of the light and the another light.

2. The LED module of claim 1, wherein a thickness of the light-converting layer of the light-guiding board is uniform.

3. The LED module of claim 1, wherein the light-converting layer is formed at a top side of the light guiding board, and the light-emergent face is formed at a top face of the light-converting layer.

4. The LED module of claim 1, wherein the light-converting layer is formed at a middle portion of the light guiding board, and the light-converting layer is below and spaced a distance from the light-emergent face.

5. The LED module of claim 4, wherein the light-emergent face is parallel to the light-converting layer.

6. The LED module of claim 1, wherein the light guiding board further comprises a light-reflecting face, the light-reflecting face and the light-emergent face are formed at two opposite sides of the light guiding board, and the light incident face is formed between the light-reflecting face and the light-emergent face.

7. The LED module of claim 6, wherein the light-reflecting face is parallel to the light-emergent face.

8. The LED module of claim 6, wherein the light-reflecting face is sloping relative to the light-emergent face.

9. The LED module of claim 6, further comprising a light-reflecting board facing the light-reflecting face of the light-guiding board.

10. The LED module of claim 9, wherein the light-reflecting board is parallel to the light-reflecting face.

11. The LED module of claim 1, wherein the light guiding board further comprises a light-reflecting face, the light incident face and the light-emergent face are formed at opposite sides of the light guiding board, and the light-reflecting face is formed between the light incident face and the light-emergent face.

12. An LED module, comprising:
an LED; and
a light-guiding board comprising a light-incident face facing the LED, a light-emergent face opposite to the light-incident face, and a light-converting layer containing phosphors therein, and light emitted from the LED moving sequentially through the light-incident face, the light-converting layer, and the light-emergent face to leave the light-guiding board;
wherein when the light moves through the light-converting layer, the light-converting layer is excited thereby to generate a second light with a wavelength different from that of the light, a mixture of the light and the second light generating a third light having a color different from those of the light and second light.

13. The LED module of claim 12, wherein a thickness of the light-converting layer of the light-guiding board is uniform.

14. The LED module of claim 12, wherein the light-converting layer is formed at a top side of the light guiding board, and the light-emergent face is formed at a top face of the light-converting layer.

15. The LED module of claim 12, wherein the light-converting layer is formed at a middle portion of the light guiding board, and the light-converting layer is spaced from the light-emergent face.

16. The LED module of claim 12, wherein the light-incident face is parallel to the light-emergent face.

17. The LED module of claim 12, further comprising a light-reflecting board facing the light-incident face of the light-guiding board.

18. The LED module of claim 17, wherein the light-reflecting board is parallel to the light-incident face.

19. The LED module of claim 17, wherein the LED is located between the light-reflecting board and the light-incident face of the light-guiding board.

20. The LED module of claim 12, wherein the phosphors are selected from YAG phosphors, RGB phosphors, and RG phosphors.
